(19) United States
(12) Patent Application Publication
(10) Pub. No.: US 2026/0331629 A1
(43) Pub. Date: Oct. 22, 2026

(54) BATTERY MODULE USING A BATTERY HEAT-DISSIPATION DEVICE OF A PULSATING HEAT PIPE

(71) Applicants: HYUNDAI MOTOR COMPANY, Seoul (KR); KIA CORPORATION, Seoul (KR)

(72) Inventors: Gun-Goo Lee, Hwaseong-si (KR); Jeong-Won Cho, Hwaseong-si (KR)

(73) Assignees: HYUNDAI MOTOR COMPANY, Seoul (KR); KIA CORPORATION, Seoul (KR)

(21) Appl. No.: 19/301,142

(22) Filed: Aug. 15, 2025

(30) Foreign Application Priority Data
Apr. 16, 2025 (KR) 10-2025-0049436

(51) Int. Cl. H01M 10/6552; F28D 15/02; H01M 10/613; H01M 10/6551; H01M 10/6569

(52) U.S. Cl. CPC H01M 10/6552; F28D 15/02; H01M 10/613; H01M 10/6551; H01M 10/6569

(57) ABSTRACT

A battery module uses a battery heat-dissipation device having a heat transfer member with a pulsating heat pipe into which an operating fluid is injected. The heat pipe has an I-shaped cross section including a vertical section of an evaporator member for vaporizing the operating fluid, a lower horizontal section of a first condenser member for liquefaction, and an upper horizontal section of a second condenser member. The pulsating heat pipe forms a dual refrigerant contact area with first and second coolant channels through first and second horizontal channel sections respectively positioned in the upper and lower horizontal sections. An area of a condenser portion is increased to increase a temperature difference between an evaporator portion in which a battery cell and a pulsating heat pipe are in direct contact with each other, thereby improving cooling performance.

### CROSS-REFERENCE TO RELATED APPLICATION

This application claims priority to Korean Patent Application No. 10-2025-0049436, filed on Apr. 16, 2025, which is incorporated herein by reference in its entirety.

### BACKGROUND OF THE DISCLOSURE

### Field of the Disclosure

The present disclosure relates to battery heat dissipation, and more particularly, to a battery module using a battery heat-dissipation device, which improves battery heat-dissipation performance by expanding a contact area with a cooling channel by a pulsating heat pipe.

### Description of Related Art

In general, valve regulated lead-acid (VRLA) batteries are mainly used for electric vehicles, but the use of lithium-ion batteries with fast charging speed and high energy density is also rapidly increasing.

Recently, the lithium-ion battery has been used not only for electric vehicles and as an energy storage system (ESS) but also as an energy source for wireless mobile devices, which are multi-functional small products, or wearable devices worn on the body as lithium secondary batteries.

In particular, the lithium-ion battery has a characteristic in which temperature increases during a charging and discharging process. The increase in temperature not only deteriorates battery performance due to a rapid decrease in efficiency, but also causes a thermal runaway phenomenon due to the melting of an electrolyte when temperature increases excessively, which can lead to a fire accident.

To this end, the lithium-ion battery uses a battery cooling method as a technology for preventing the spread of thermal runaway of cells due to heat transfer to other battery cells when a specific cell among a plurality of closely arranged battery cells (or battery cells) experiences a rapid temperature rise. The battery cooling method can be classified into a method that absorbs and dissipates heat through metal heat-dissipation fins and a method that uses a cooling plate with a flow path.

Accordingly, the metal heat-dissipation fin method and the flow path-type cooling plate method reduce a risk of fire in lithium-ion batteries by preventing heat transfer to other surrounding battery cells due to a battery cell with a temperature that has rapidly risen among the plurality of closely arranged battery cells.

However, the metal heat-dissipation fin method has a problem in that cooling performance is not high. The flow path-type cooling plate method has a problem in that cooling performance is high using coolant, but a flow rate, which is supplied by the same pumping power when a pump pumps the coolant, is small. This is due to a pressure drop in the flow path. Heat capacity is also small. Thus, efficient cooling is not easy at an outlet compared to an inlet of the flow path.

### SUMMARY OF THE DISCLOSURE

The present disclosure is directed to providing a battery module using a battery heat-dissipation device of a pulsating heat pipe, which expands a contact area with a cooling channel by a pulsating heat pipe. Battery heat dissipation performance is thereby improved. In particular, this increases a temperature difference between an evaporator area in which a battery cell and a pulsating heat pipe are in direct contact with each other by expanding an area of a condenser area. This improves cooling performance with the expanded contact area with the cooling channel and also facilitates assembly of the battery module.

According to the present disclosure, a battery heat-dissipation device is provided and includes a heat transfer member having an I-shaped cross section formed by a lower horizontal section of a first condenser member and an upper horizontal section of a second condenser member using an evaporator member as a vertical section. The battery heat-dissipation device also includes a pulsating heat pipe, which is embedded in the heat transfer member and into which an operating fluid is injected.

The pulsating heat pipe is composed of a vertical channel section positioned in the evaporator member forming a heat transfer area of external heat at a middle portion, a first horizontal channel section positioned in the first condenser member forming a first refrigerant contact area of external coolant on a lower portion, and a second horizontal channel section positioned in the second condenser member forming a second refrigerant contact area of the external coolant on an upper portion.

The operating fluid is vaporized in the vertical channel section with the heat transfer area. The operating fluid is liquefied in each of the first horizontal channel section and the second horizontal channel section with a double area of the first refrigerant contact area and the second refrigerant contact area.

Bonding portions between the evaporator member, the first condenser member, and the second condenser member are brazing-welded.

The evaporator member is composed of a channel plate on which a vertical channel pattern is formed matching the vertical channel section. A channel cover is coupled to the channel plate to cover the vertical channel section.

Each of the first condenser member and the second condenser member is composed of a vertical channel plate having vertical channel grooves that match the vertical channel section and that are perforated therein and a horizontal channel plate having a horizontal channel pattern formed therein that matches the first horizontal channel section or the second horizontal channel section of the heat pipe. The vertical channel section, the first horizontal channel section, and the second horizontal channel section are integrally connected.

The pulsating heat pipe may form a horizontal connection channel in the second horizontal channel section and the horizontal connection channel expands a refrigerant contact area formed by the second condenser member and external coolant.

According to the present disclosure, a battery heat-dissipation device is provided and includes a heat transfer member having an I-shaped cross section formed by a lower horizontal section of a first condenser member and an upper horizontal section of a second condenser member using an evaporator member as a vertical section. The heat-dissipation device also includes a pulsating heat pipe, which is embedded in the heat transfer member and into which an operating fluid is injected. The pulsating heat pipe is composed of: a vertical channel section positioned in the evaporator member forming a heat transfer area of external heat at a middle portion and connecting an upper end of the vertical channel section to arc-shaped upper connectors; a first horizontal channel section positioned in the first condenser member forming a first refrigerant contact area of external coolant on a lower portion; and an upper channel positioned in the second condenser member forming a second refrigerant contact area of the external coolant on an upper portion and connecting both outermost edges of the vertical channel section in a straight line.

The operating fluid is vaporized in the vertical channel section with the heat transfer area. The operating fluid is liquefied in each of the first horizontal channel section and the upper channel with a double area of the first refrigerant contact area and the second refrigerant contact area.

According to the present disclosure, a battery heat-dissipation device is provided and includes a heat transfer member having an I-shaped cross section formed by a lower horizontal section of a first condenser member and an upper horizontal section of a second condenser member using an evaporator member as a vertical section. The battery heat-dissipation device also includes a pulsating heat pipe, which is embedded in the heat transfer member and into which an operating fluid is injected. The pulsating heat pipe is composed of: a vertical channel section positioned in the evaporator member forming a heat transfer area of external heat at a middle portion and connecting a lower end of the vertical channel section to arc-shaped lower connectors; a lower channel positioned in the first condenser member forming a first refrigerant contact area of external coolant on a lower portion and connecting both outermost edges of the vertical channel section in a straight line; and a second horizontal channel section positioned in the second condenser member forming a second refrigerant contact area of the external coolant on an upper portion.

The operating fluid is vaporized in the vertical channel section with the heat transfer area. The operating fluid is liquefied in each of the second horizontal channel section and the lower channel with a double area of the first refrigerant contact area and the second refrigerant contact area.

According to the present disclosure, a battery module is provided and includes: a battery heat-dissipation device having a pulsating heat pipe into which an operating fluid is injected, and a heat transfer member having an I-shaped cross section formed by a lower horizontal section, an upper horizontal section, and a vertical section; a first battery cell and a second battery cell that are positioned on both sides of the vertical section of the heat transfer member and that generate heat for vaporizing the operating fluid; a first gap filler and a second gap filler respectively positioned in the lower horizontal section and the upper horizontal section of the heat transfer member; and a first coolant channel and a second coolant channel, which are positioned in the lower horizontal section and the upper horizontal section of the heat transfer member and along which coolant for liquefying the operating fluid flows.

The pulsating heat pipe includes: a vertical channel section positioned in the evaporation member forming heat transfer areas of the first gap filler and the second gap filler in the vertical section of the heat transfer member; a first horizontal channel section positioned in the first condenser member forming a first refrigerant contact area of the first coolant channel in the lower horizontal section of the heat transfer member; and a second horizontal channel section positioned in the second condenser member forming a second refrigerant contact area of the second coolant channel in the upper horizontal section of the heat transfer member.

The first horizontal channel section is embedded in the first gap filler to form the first refrigerant contact area with the first coolant channel. The second horizontal channel section is embedded in the second gap filler to form the second refrigerant contact area with the second coolant channel.

The first battery cell and the second battery cell are configured as a battery cell unit with the heat transfer member interposed between the cells. The battery cell units are arranged continuously with a surface pressure pad interposed therebetween.

In the battery module using the battery heat-dissipation device of the pulsating heat pipe (PHP) of the present disclosure, the contact area between the cooling channel and the PHP, which is effective for heat dissipation performance, can be expanded by modifying the PHP of the battery module that performs double-sided cooling into an I shape.

Accordingly, in the battery module using the battery heat-dissipation device of the pulsating heat pipe of the present disclosure, it is possible to increase the temperature difference between the evaporator portion, which is the portion in which the battery cell and the PHP are in direct contact with each other, and the condenser portion by increasing the surface area of the condenser portion in the high-voltage battery in which it is difficult to increase the surface area of the evaporator portion. A greater temperature difference can exhibit much higher heat dissipation performance, thereby contributing to improving the performance of the PHP and in particular, improving manufacturability when manufacturing the battery module, thereby facilitating the manufacturing of the battery module.

### BRIEF DESCRIPTION OF THE DRAWINGS

FIG. 1 is a view showing a configuration of a battery heat-dissipation device using a heat transfer member and an I-shaped pulsating heat pipe according to the present disclosure.

FIG. 2 is a view showing a configuration of a battery module to which an I-shaped battery heat-dissipation device according to the present disclosure is applied.

FIG. 3 is an illustration of a heat discharge principle of a pulsating heat pipe according to the present disclosure.

FIG. 4 is a view showing an exploded view of a heat transfer member according to the present disclosure.

FIG. 5 is a perspective view and a cross-sectional view of the inside of a battery heat-dissipation device according to the present disclosure.

FIG. 6 are views showing examples of various shapes of a pulsating heat pipe according to the present disclosure.

FIG. 7 are views showing a modified example of a structure of the heat transfer member according to various shapes of a pulsating heat pipe according to the present disclosure.

### DESCRIPTION OF SPECIFIC EMBODIMENTS

Hereinafter, embodiments of the present disclosure are described in detail with reference to the accompanying drawings. These embodiments are examples and can be implemented in various different forms by those of ordinary skill in the art to which the present disclosure pertains. Thus, the scope of the present disclosure is not limited to embodiments disclosed herein. When a component, device, unit, module, member, element, apparatus, or the like of the present disclosure is described as having a purpose or performing an operation, function, or the like, the component, device, unit, module, member, element, apparatus, or the like should be considered herein as being “configured to” meet that purpose or to perform that operation or function.

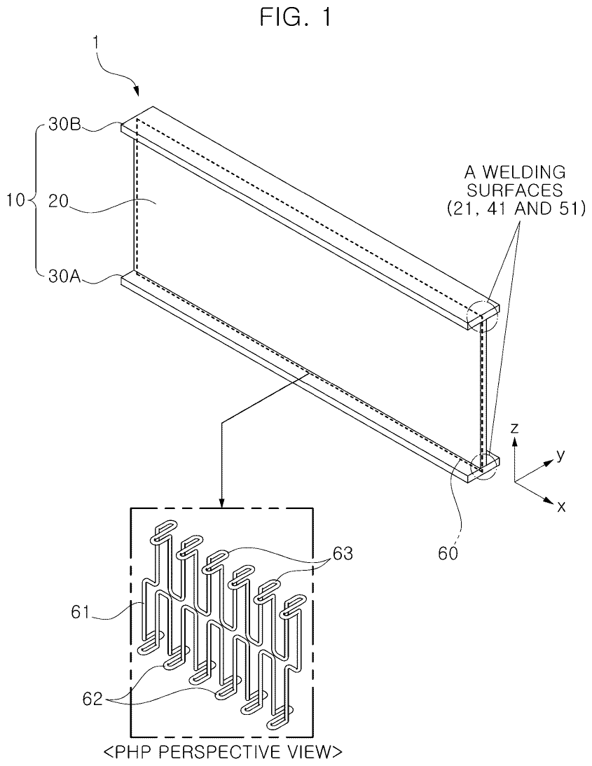

Referring to FIG. 1, a battery heat-dissipation device 1 is composed of a heat transfer member 10 and a pulsating heat pipe or PHP 60.

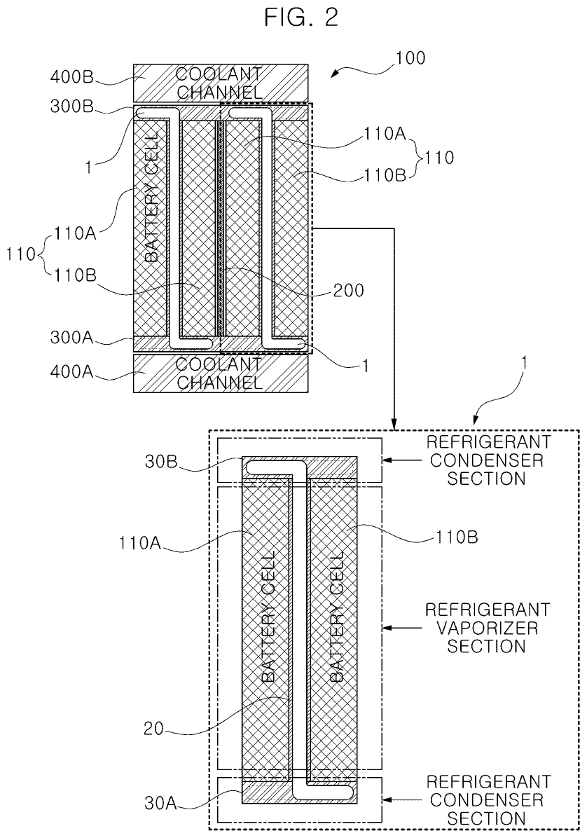

For example, the heat transfer member 10 is formed in a rectangular shape with an I-shaped cross section and defines or forms an external structure of the battery heat-dissipation device 1. The heat transfer member 10 is formed of a material with excellent thermal conductivity to prevent a temperature deviation between cells due to heat transfer between battery cells 110A and 110B (see FIG. 2). In this case, considering a material having a considerably low thermal conductivity of the battery cell (e.g., 25 W/mK or less in a surface direction and 2 W/mK or less in a thickness direction) compared to metal, aluminum (Al) or copper (Cu) may be used for the heat transfer member 10.

To this end, the heat transfer member 10 forms an I-shaped cross section by combining an evaporator member 20, a first condenser member 30A, and a second condenser member 30B. The evaporator member 20 has a height in a vertical direction (i.e., a z-axis direction of an xyz coordinate system). The pulsating heat pipe 60 is embedded therein with a predetermined thickness. The first condenser member 30A has a predetermined width in a horizontal direction (i.e., a y-axis direction of the xyz coordinate system) and is positioned on a lower end of the evaporator member 20. The second condenser member 30B has a predetermined width in the horizontal direction (i.e., the y-axis direction of the xyz coordinate system) and is positioned on an upper end of the evaporator member 20. In this case, sizes of the widths of the first and second condenser members 30A and 30B are set to be the same but may be set differently as needed.

For example, the pulsating heat pipe 60 is an internal structure of the heat transfer member 10 that may be implemented as a soft and easily bendable pipe. The pulsating heat pipe 60 may be manufactured in various shapes. In one example, the pulsating heat pipe 60 may form or define an I-shaped channel, i.e., flow path, tube, pipe, line, conduit, duct, etc., configuration that matches the I-shaped cross section of the heat transfer member 10 and that is continuous in a longitudinal direction (i.e., the x-axis direction of the xyz coordinate system). An operating fluid (or refrigerant) may be injected into the I-shaped hollow channel and is moved by vibration due to the temperature difference to allow the heat applied to the heat transfer member 10 to be dissipated.

To this end, the pulsating heat pipe 60 transforms a single straight pipe into a continuous complex curved shape, in this example, an I-shaped channel when viewed on end. The shape of the I-shaped channel includes a vertical channel section 61 having a height in the vertical direction (i.e., the z-axis direction of the xyz coordinate system) defined by upper and lower portions. A first horizontal channel section 62 transitions from a lower end of the lower portion of the vertical channel section 61 in the horizontal direction (i.e., the y-axis direction of the xyz coordinate system). A second horizontal channel section 63 transitions from an upper end of the upper portion of the vertical channel section 61 in the horizontal direction (i.e., the y-axis direction of the xyz coordinate system).

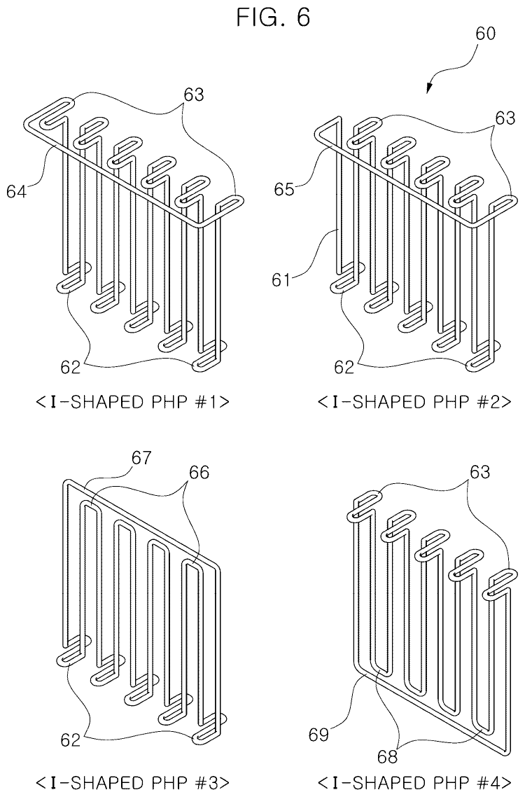

Accordingly, the upper and lower portions of the vertical channel section 61 may have straight portions with U-shaped bent sections. Each of the first and second horizontal channel sections 62 and 63 may have a “∪∩” shape, i.e., an exaggerated “S” shape or a double reversed “J” or double reversed “U” shape and such a complex shape of the channel may be variously transformed as shown in FIG. 6.

Accordingly, the vertical channel section 61 is positioned in the evaporator member 20 of the heat transfer member 10. The first horizontal channel section 62 is positioned in the first condenser member 30A of the heat transfer member 10. The second horizontal channel section 63 is positioned in the second condenser member 30B of the heat transfer member 10.

Referring to FIG. 2, an example in which a battery module 100 to which the battery heat-dissipation device 1 is applied is shown.

For example, the battery heat-dissipation device 1 is the same device composed of the heat transfer member 10 and the pulsating heat pipe 60 of FIG. 1, but the size (i.e., a width, length, and thickness) of the battery heat-dissipation device 1 is determined depending on the sizes and cell gap of the battery cells 110A and 110B of the battery module 100.

As shown, the battery module 100 includes a battery cell unit 110, a surface pressure pad 200, gap fillers 300A and 300B, and coolant channels 400A and 400B. In this case, the battery module 100 constitutes a high-voltage battery.

For example, the battery cell unit 110 is composed of a pair of first and second battery cells 110A and 110B. The evaporator member 20 of the heat transfer member 10 has the vertical channel section 61 of the pulsating heat pipe 60 embedded therein and is positioned between the first battery cell 110A and the second battery cell 110B.

Accordingly, the heat transfer member 10 may form the evaporator member 20 being in contact with each of the first and second battery cells 110A and 110B as a refrigerant vaporizer. The refrigerant vaporizer may vaporize the operating fluid provided in the vertical channel section 61 of the pulsating heat pipe 60 through the heat generation of the first and second battery cells 110A and 110B.

In addition, the surface pressure pad 200 is positioned between neighboring battery cell units 110 arranged side by side to correct a change in thickness of the battery cell due to a pressing force applied when the battery module 100 is assembled. In particular, the surface pressure pad 200 can evenly maintain a repulsive force (i.e., surface pressure).

For example, the gap fillers are composed of a pair of first and second gap fillers 300A and 300B. The first gap filler 300A is positioned on a lower end of the battery cell unit 110 so that the first condenser member 30A of the heat transfer member 10 having the first horizontal channel section 62 of the pulsating heat pipe 60 embedded therein is properly positioned. The second gap filler 300B is positioned on an upper end of the battery cell unit 110 so that the second condenser member 30B of the heat transfer member 10 having the second horizontal channel section 63 of the pulsating heat pipe 60 embedded therein is properly positioned. In this case, the first and second gap fillers 300A and 300B match the entire length of the battery module 100.

In addition, the coolant channels are composed of a pair of first and second coolant channels 400A and 400B that are passages in which coolant for cooling the battery cell unit 110 circulates. The first coolant channel 400A is positioned below the first gap filler 300A to cool the first condenser member 30A of the heat transfer member 10. The second coolant channel 400B is positioned above the second gap filler 300B to cool the second condenser member 30B of the heat transfer member 10. In this case, the first and second coolant channels 400A and 400B match the entire length of the battery module 100.

Accordingly, the heat transfer member 10 forms the first and second condenser members 30A and 30B being in contact with the first and second coolant channels 400A and 400B, respectively, as two upper and lower refrigerant condenser sections. The upper and lower refrigerant condenser sections liquefy the operating fluid provided in the first and second horizontal channel sections 62 and 63 of the pulsating heat pipe 60 through cooling by the refrigerant of the first and second coolant channels 400A and 400B.

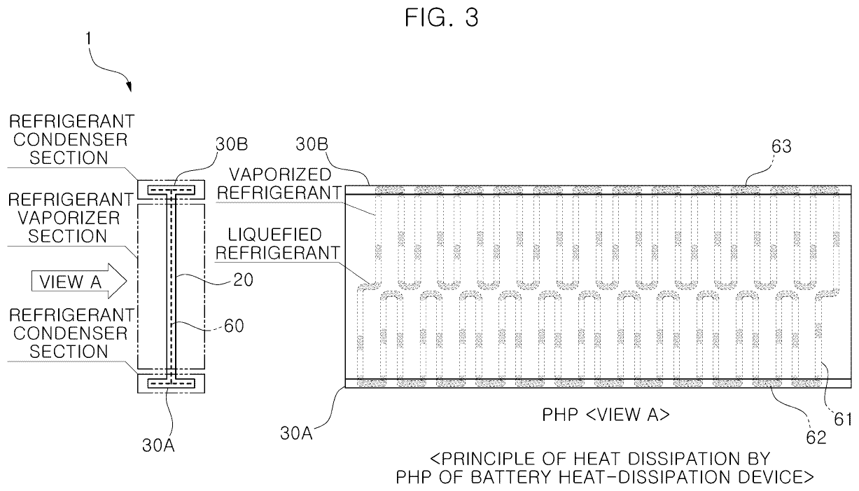

Referring to FIG. 3, the heat transfer member 10 forms the refrigerant vaporizer section by the evaporator member 20 and the upper and lower refrigerant condenser sections by the first and second condenser members 30A and 30B. The pulsating heat pipe 60 has the vertical channel section 61 positioned in the refrigerant vaporizer section and the first and second horizontal channel sections 62 and 63 positioned in the upper and lower refrigerant condenser sections.

Accordingly, the operating fluid of the pulsating heat pipe 60 may be moved by vibrations generated by repeating processes of being vaporized at high temperatures of the first and second battery cells 110A and 110B in the refrigerant vaporizer section, being liquefied at a low temperature of the second coolant channel 400B in the upper coolant condenser section, being re-vaporized at the high temperatures of the first and second battery cells 110A and 110B in the refrigerant vaporizer section, and being re-liquefied at a low temperature of the first coolant channel 400A in the lower coolant condenser section.

Accordingly, it is possible to solve a problem of a typical T-shaped pulsating heat pipe having only one coolant condenser section present on an upper or lower side. In such a T-shaped pulsating heat pipe, when the heat generation of the battery cell significantly increases, the vaporized refrigerant moves quickly without being condensed in the condenser section and is re-supplied to the vaporizer section, and thus the battery cannot be cooled.

In other words, since the I-shaped pulsating heat pipe 60 sufficiently condenses the vaporized refrigerant and converts the condensed refrigerant into a liquefied refrigerant using two refrigerant condenser sections compared to the T-shaped pulsating heat pipe, it is possible to achieve a more effective cooling effect with a quick charging time of a battery.

By repeating processes of “shortening a quick charging time of a battery→increasing heat generation of the battery→transferring heat from a battery cell to a PHP refrigerant vaporizer section→vaporizing refrigerant and moving the vaporized refrigerant to a gas condenser section→liquefying the refrigerant in a PHP refrigerant condenser section→moving the liquefied refrigerant to the PHP refrigerant vaporizer section→allowing the refrigerant to absorb heat from the battery cell” to continuously discharge the heat absorbed from the battery cell to the coolant channels, the battery can reach an appropriate temperature more quickly.

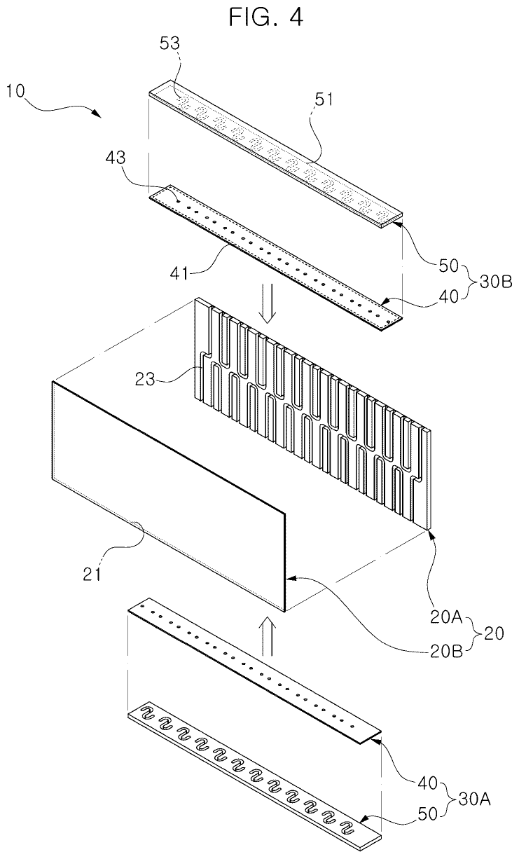

FIGS. 4-7 show specific configurations of the heat transfer member 10 and the pulsating heat pipe 60 that constitute the battery heat-dissipation device 1.

Referring to the heat transfer member 10 of FIG. 4, the evaporator member 20 is composed of a channel plate 20A and a channel cover 20B. Each of the first condenser member 30A and the second condenser member 30B is composed of a vertical channel plate 40 and a horizontal channel plate 50, i.e. the channels associated with each plate are oriented vertically through the plate or horizontally along the plate, respectively.

In particular, the channel plate 20A and the channel cover 20B face each other. The vertical channel plate 40 and the horizontal channel plate 50 overlap or face each other. Bonding surfaces of these components 20A, 20B, 40, and 50 are brazing-welded so that an internal space formed between the components may form a closed volume.

For example, the channel plate 20A and the channel cover 20B are each formed in a rectangular or quadrangular plate structure having the same predetermined thickness and size (e.g., width). Brazing-welding is performed on one surface of the plates facing each other with a welding surface 21 formed along an edge.

However, the channel plate 20A may be fitted with the vertical channel section 61 of the pulsating heat pipe 60 using a vertical channel pattern 23 by forming an internal space of the welding surface 21 as a pattern surface having the vertical channel pattern 23. However, the channel cover 20B may be in contact with the vertical channel section 61 by forming the internal space of the welding surface 21 as a flat surface, thereby enhancing the heat transfer effect.

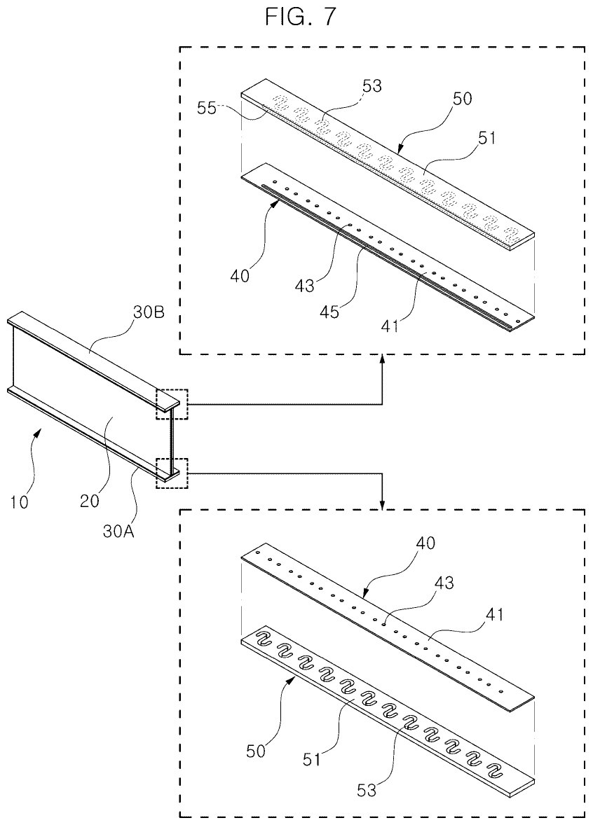

For example, the vertical channel plate 40 and the horizontal channel plate 50 are each formed in a rectangular or quadrangular plate structure having the same predetermined thickness and size (e.g., width), and brazing-welding is performed on one surface of the plates facing each other with welding surfaces 41 and 51 formed along an edge. In this case, the vertical channel plate 40 may be divided into two parts centered on the vertical channel pattern 23 so that the vertical channel section 61 and vertical connection channels 67 and 69 (see FIG. 6) may be inserted into the vertical channel plate 40 and then integrated by brazing-welding, or may be divided into three parts centered on the vertical channel pattern 23 and a channel slot 45 (see FIG. 7) so that the vertical channel section 61 and horizontal connection channels 64 and 65 (see FIG. 6) may be inserted into the vertical channel plate 40 and then integrated by brazing welding. This may also be applied to the horizontal channel plate 50.

However, the vertical channel plate 40 may form the internal space of the welding surface 21 as a channel surface having a vertical channel groove 43 so that the vertical channel section 61 of the pulsating heat pipe 60 may pass therethrough using the vertical channel groove 43, but the horizontal channel plate 50 may form the internal space of the welding surface 21 as a pattern surface having a horizontal channel pattern 53 so that the first and second horizontal channels 62 and 63 of the pulsating heat pipe 60 may be fitted with into the horizontal channel plate 50 using the horizontal channel pattern 53.

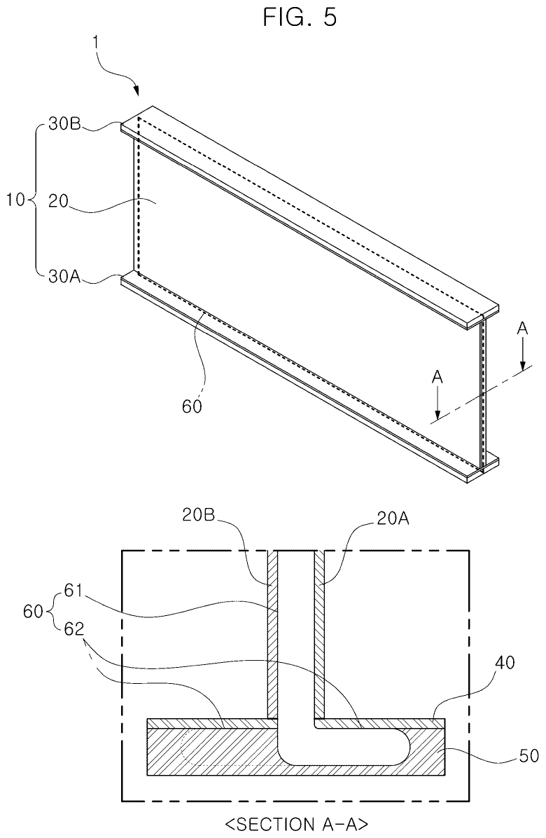

Referring to a cross-sectional structure along line A-A in FIG. 5, the pulsating heat pipe 60 has a diameter of a pipe larger than the sum of thicknesses of the channel plate 20A and the channel cover 20B, but the diameter of the pipe is formed to be smaller than the sum of thicknesses of the vertical channel plate 40 and the horizontal channel plate 50.

As shown, when the pulsating heat pipe 60 is assembled to the channel plate 20A, the channel cover 20B, the vertical channel plate 40, and the horizontal channel plate 50, the pipes segments of the vertical channel section 61 pass through the vertical channel grooves 43, i.e., holes or apertures, and exit the vertical channel plate 40 in a state of being positioned in an internal space of the channel plate 20A and the channel cover 20B and seated in or aligned with the vertical channel pattern 23. The first horizontal channel section 62 is positioned in the horizontal channel plate 50 while fitted with the horizontal channel pattern 53 of the first condenser member 30A. In this case, the second horizontal channel section 63 of the pulsating heat pipe 60 is positioned while fitted with the horizontal channel pattern 53 of the second condenser member 30B like the assembly structure of the first horizontal channel section 62.

Referring to FIG. 6, the pulsating heat pipe 60 may be configured as one of an I-shaped PHP #1, PHP #2, or the like, or may be configured to be an alternate shaped PHP #3, PHP #4, or the like.

Accordingly, the shapes of the I-shaped PHP #1 to the alternate shaped PHP #4 have the following differences from the shapes of the vertical, first, and second horizontal channel sections 61, 62, and 63 of FIG. 1.

For example, the structure of the I-shaped PHP #1 includes the first horizontal connection channel section 64 while the first horizontal channel section 62 is applied to the lower end of the vertical channel section 61. The second horizontal channel section 63 is applied to the upper end thereof. The first horizontal connection channel 64 is formed by protruding forward (i.e., in the x-axis direction of the xyz coordinate system) from the same horizontal plane as the second horizontal channel section 63.

In addition, the structure of the I-shaped PHP #2 includes the second horizontal connection channel 65 while the first horizontal channel section 62 is applied to the lower end of the vertical channel section 61 and the second horizontal channel section 63 is applied to the upper end thereof. The second horizontal connection channel 65 is formed by protruding forward (i.e., in the x-axis direction of the xyz coordinate system) from the second horizontal channel section 63.

Accordingly, the first horizontal connection channel 64 of the I-shaped PHP #1 lies in the same horizontal plane as the second horizontal channel section 63 at the upper end of the vertical channel section 61. The first horizontal connection channel 64 connects the exaggerated “S” (or “double reversed J or U”) shapes of two second horizontal channels section 63 forming left/right outermost edges (i.e., in the y-axis direction of the xyz coordinate system) among the second horizontal channels 63 in a straight line. The second horizontal connection channel 65 of the I-shaped PHP #2 lies in the same horizontal plane as the second horizontal channel section 63 on the upper end of the vertical channel section. 61. The second horizontal connection channel 65 connects the exaggerated “S” shape of one portion of the second horizontal channel section 63 forming a right outermost edge of the second horizontal channel section 63 to the upper end of one portion of the vertical channel section 61 forming a left outermost edge among the vertical channel section 61 with a straight line.

For example, in the structure of the PHP #3, the first horizontal channel section 62 is applied to the lower end of the vertical channel section 61. Instead of the second horizontal channel section 63 being applied, a combination of upper connector portions 66 and an upper channel 67 is applied to the upper end of the vertical channel section 61. Instead of the second horizontal channel section 63 being applied, the upper connectors 66 connect two adjacent vertical segments of the vertical channel section 61 among the vertical channel section 61 in an arc shape. The upper channel 67 is formed to protrude upward (i.e., in the z-axis direction of the xyz coordinate system) in the same vertical plane as the upper connectors 66.

In addition, in the structure of the PHP #4, the second horizontal channel section 63 is applied to the upper end of the vertical channel section 61. Instead of the first horizontal channel section 62 being applied, a combination of lower connectors 68 and a lower channel 69 is applied to the lower end of the vertical channel section 61. Instead of the first horizontal channel section 62, the lower connectors 68 connect two adjacent vertical segments of the vertical channel section 61 among the vertical channel section 61 in an arc shape. The lower channel 69 is formed to protrude downward (i.e., in the z-axis direction of the xyz coordinate system) in the same vertical plane as the lower connectors 68.

Accordingly, the upper channel 67 of the PHP #3 lies in the same vertical plane as the upper connectors 66 at the upper end of the vertical channel section 61. The upper channel 67 connects upper ends of the two vertical segments of the vertical channel section 61 forming the left and right outermost edges among the vertical channel section 61 with a straight line. The lower channel 69 of the PHP #4 lies in the same vertical plane as the lower connectors 68 at the lower end of the vertical channel section 61. The lower channel 69 connects lower ends of the two vertical segments of the vertical channel section 61 forming the left and right outermost edges with a straight line.

In addition, since the PHP #3 and the PHP #4 may be disposed vertically, the pulsating heat pipe 60 may be configured as a new I-shaped PHP #5 (not shown). In particular, the I-shaped PHP #5 may form a component (i.e., the pulsating heat pipe 60) in a shape in which the PHP #3 and the PHP #4 enter lower and upper parts of the device with half a length and combine to form the I-shape.

Referring to FIG. 7, an example in which, in the heat transfer member 10, a structure of the first condenser member 30A or the second condenser member 30B is changed according to the I-shaped PHP #1 to the PHP #4 is shown.

As shown, an example in which, in the heat transfer member 10, the structures of the vertical channel plate 40 and the horizontal channel plate 50 of the second condenser member 30B are changed according to the first horizontal connection channel 64 of the I-shaped PHP #1, the second horizontal connection channel 65 of the I-shaped PHP #2, and the upper channel 67 of the PHP #3 is shown.

To this end, the vertical channel plate 40 forms the straight channel slot 45 that is perforated in the plate body in the same manner as the vertical channel groove 43 at an adjacent position of the vertical channel groove 43 while maintaining the welding surface 41 and the vertical channel groove 43. The horizontal channel plate 50 forms a straight channel groove 55 that is perforated in the plate body in the same manner as the horizontal channel pattern 53 at an adjacent position of the horizontal channel pattern 53 while maintaining the welding surface 51 and the horizontal channel pattern 53.

In the same manner, in the heat transfer member 10, by structurally changing the first condenser member 30A while maintaining the second condenser member 30B according to the lower channel 69 of the PHP #4, the straight channel slot 45 may be formed in the vertical channel plate 40, and the straight channel groove 55 in the horizontal channel plate 50.

As described above, the battery module using the battery heat-dissipation device of the pulsating heat pipe according to the present disclosure has the heat transfer member 10 including the pulsating heat pipe 60 into which the operating fluid is injected. The battery heat-dissipation device is formed to have the I-shaped cross section by combining the vertical section of the evaporator member 20 for vaporizing the operating fluid, the lower horizontal section of the first condenser member 30A for liquefaction, and the upper horizontal section of the second condenser member 30B. The pulsating heat pipe 60 forms a dual refrigerant contact area with the first and second coolant channels 400A and 400B through the first and second horizontal channel sections 62 and 63 respectively positioned in the upper and lower horizontal sections. The area of the condenser portion is thereby increased to increase the temperature difference between an evaporator portion in which a battery cell and a pulsating heat pipe are in direct contact with each other, thereby improving cooling performance.

The example embodiments described herein are to be considered in a descriptive sense only, and not for purposes of limitation. Therefore, the scope of the present disclosure is defined not by the detailed description, but by the claims and their equivalents. All variations within the scope of the claims and their equivalents are to be construed as being included in the present disclosure.

What is claimed is:

1. A battery heat-dissipation device comprising:
a heat transfer member composed of an evaporator member, a first condenser member forming a lower horizontal plane with the evaporator member, and a second condenser member forming an upper horizontal plane with the evaporator member; and
a heat pipe embedded in the heat transfer member.

2. The battery heat-dissipation device of claim 1, wherein the heat transfer member has an I-shaped cross section formed by the evaporator member, the first condenser member, and the second condenser member.

3. The battery heat-dissipation device of claim 1, wherein a shape of the heat pipe conforms to shapes of the evaporator member, the first condenser member, and the second condenser member.

4. The battery heat-dissipation device of claim 3, wherein the heat pipe comprises:
a vertical channel section positioned in the evaporator member;
a first horizontal channel section positioned in the first condenser member; and
a second horizontal channel section positioned in the second condenser member.

5. The battery heat-dissipation device of claim 4, wherein the vertical channel section, the first horizontal channel section, and the second horizontal channel section are arranged to have an I-shaped cross section.

6. The battery heat-dissipation device of claim 5, wherein the second horizontal channel section has horizontal connection channels.

7. The battery heat-dissipation device of claim 5, wherein the vertical channel section is seated in a vertical channel pattern recessed in the evaporator member.

8. The battery heat-dissipation device of claim 5, wherein the first horizontal channel section is seated in a horizontal channel pattern recessed in the first condenser member, and wherein the second horizontal channel section is seated on the horizontal channel pattern recessed in the second condenser member.

9. The battery heat-dissipation device of claim 3, wherein the heat pipe includes:
a vertical channel section positioned in the evaporator member;
a first horizontal channel section positioned in the first condenser member; and
an upper channel positioned in the second condenser member.

10. The battery heat-dissipation device of claim 9, wherein an upper end of the vertical channel section includes arc-shaped upper connectors adjacent the upper channel connector.

11. The battery heat-dissipation device of claim 3, wherein the heat pipe includes:
a vertical channel section positioned in the evaporator member;
a lower channel positioned in the first condenser member; and
a second horizontal channel section positioned in the second condenser member.

12. The battery heat-dissipation device of claim 11, wherein a lower end of the vertical channel section includes arc-shaped lower connectors disposed adjacent the lower channel.

13. A battery module comprising:
a battery heat-dissipation device including a heat transfer member composed of an evaporator member, a first condenser member having a lower horizontal surface coupled to the evaporator member, and a second condenser member having an upper horizontal surface coupled to the evaporator member, and a heat pipe embedded in the evaporator member, the first condenser member, and the second condenser member;
a battery cell positioned adjacent to the evaporator member;
a gap filler in the first condenser member and the second condenser member; and
a coolant channel in the gap filler.

14. The battery module of claim 13, wherein the battery heat-dissipation device
has an I-shaped cross section including the heat transfer member and the heat pipe.

15. The battery module of claim 14, wherein the heat pipe includes:
a vertical channel section positioned in the evaporator member;
a first horizontal channel section positioned in the first condenser member; and
a second horizontal channel section positioned in the second condenser member.

16. The battery module of claim 13, wherein the battery cell comprises a first battery cell and a second battery cell positioned at opposed sides of the evaporator member.

17. The battery module of claim 16, wherein:
the first battery cell and the second battery cell constitute a battery cell unit; and
a plurality of the battery cell units are arranged continuously with a surface pressure pad interposed therebetween.

18. The battery module of claim 13, wherein the gap filler includes a first gap filler surrounding the first condenser member and a second gap filler surrounding the second condenser member.

19. The battery module of claim 18, wherein the coolant channel includes a first coolant channel positioned in the first gap filler and a second coolant channel positioned in the second gap filler.
